(19) United States
(12) Patent Application Publication
(10) Pub. No.: US 2026/0253298 A1
(43) Pub. Date: Aug. 27, 2026

(54) SHAPE AWARE DESCRIPTIVE MOVEMENT SYNTHESIS

(71) Applicant: Adobe Inc., San Jose, CA (US)

(72) Inventors: Uttaran Bhattacharya, Sunnyvale, CA (US); Yu Shen, Oakland, CA (US); Yi Zhou, San Jose, CA (US); Ting-hsuan Liao, College Park, MD (US); Saayan Mitra, San Jose, CA (US); Chun-hao Huang, London (GB)

(73) Assignee: Adobe Inc., San Jose, CA (US)

(21) Appl. No.: 19/063,513

(22) Filed: Feb. 26, 2025

(51) Int. Cl. G06T 13/40; G06T 17/00

(52) U.S. Cl. CPC G06T 13/40; G06T 17/00

(57) ABSTRACT

Techniques for shape aware descriptive movement synthesis are described. In an example, a processing device is operable to receive a description of a body motion and a body, used as input to a trained machine learning system that generates motion data from the description. A shape parameter and a plurality of motion tokens are jointly predicted by the machine learning system based on the description. A plurality of discrete motion features is obtained from applying a finite scalar de-quantization to the motion tokens. Using the machine learning system, the processing device generates a plurality of shape conditioned motion features by integrating a shape feature projected from the shape parameter with the discrete motion features. The shape conditioned motion features are decoded by the machine learning system into the motion data, which models the motion with specific variations caused by the shape.

### BACKGROUND

Existing 3D modeling tools automate aspects of body movement synthesis to improve efficiency and quality of body motion models created for animating digital content. A degree of realism achievable with conventional movement synthesis tools is limited. Body motion models that support animations often fail to account for body movement variations across different body shapes. Conventional approaches balance complexity and efficiency by normalizing body motion models based on standardized body shape models. A one size fits all approach to movement synthesis overlooks distinct, observable physiological differences caused when different body shapes perform similar movements. Homogenizing body motions and disregarding body shape induced variations fails to achieve realistic motion effects caused by different body shapes, potentially introduces artifacts in the motion synthesis process, which causes further inaccuracies.

### SUMMARY

Shape aware descriptive movement synthesis is described to address conventional technical challenges encountered when synthesizing body motions that accurately represent motion effects observed when different body shapes perform the synthesized movements. A machine learning system is described that integrates body shape descriptions and motion descriptions, with body motion synthesis techniques.

The system processes textual descriptions of body motion and shape through a large language model trained to jointly predict a shape parameter and motion tokens. The joint predictions capture nuanced physiological differences in how individuals with varying body types perform various movements. The joint predictions introduce realism in motion effects caused by different body shapes, which is unachievable by conventional techniques that disregard body shape induced variations by harmonizing body motions, including to prevent artifacts introduced in the movement synthesis, which further increases accuracy. The joint predictions are processed through a trained finite scalar quantizer and a combiner, which integrates a shape feature projected from the shape parameter with discrete motion features to generate shape conditioned motion features. The shape integration possibly improves parameterizing motions based on body shape variations and learning fine grained motion differences caused by varying body shapes. A trained motion decoder transforms the shape conditioned motion features into motion data, which potentially enhances realism for applications in content creation, simulation, gaming, and interactive media. The system outputs the motion data, usable to generate a realistic animation of the described body shape performing the described body motion. Unlike conventional motion synthesis techniques, which standardize motions based on a normalized human body model, the machine learning system outputs motion data tailored to diverse body shapes described by inputs, e.g., text inputs, transcribed audio inputs. An animation rendered from the motion data depicts motion variations observed with movements made by the described body shape. The system output allows for more realistic and diverse animations, addressing limitations of conventional one size approaches that fail to account for shape specific motion characteristics.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF FIGURES

The detailed description is described with reference to the accompanying figures. Entities represented in the figures are indicative of one or more entities and thus reference is made interchangeably to single or plural forms of the entities in the discussion.

FIG. 1 illustrates a block diagram of an environment of a content processing system in an example implementation that is operable to employ techniques described herein for shape aware descriptive movement synthesis.

FIG. 2 illustrates a block diagram of a machine learning system trained to employ techniques described herein for shape aware descriptive movement synthesis.

FIG. 3a illustrates a block diagram of first training stage of a training architecture of the machine learning system shown in FIG. 2.

FIG. 3b illustrates a block diagram of second training stage of the training architecture of the machine learning system shown in FIG. 2.

FIG. 4 illustrates examples of inputs to and corresponding outputs from a content processing system that is operable to employ techniques described herein for shape aware descriptive movement synthesis.

FIG. 5 shows a flow diagram depicting an algorithm as a step by step process, which is performable by a processing device for training a machine learning system to implement shape aware descriptive movement synthesis.

FIG. 6 shows a flow diagram depicting an algorithm as a step by step process, which is performable by a processing device for implementing shape aware descriptive movement synthesis.

FIG. 7 shows a flow diagram depicting an algorithm as a step by step process, which is performable by a processing device when executing a training module for training a machine learning system to implement shape aware descriptive movement synthesis.

FIG. 8 illustrates an example system including various components of an example device usable as any type of computing device as described and/or utilized with reference to FIGS. 1 7 to implement examples of the techniques described herein.

### DETAILED DESCRIPTION

### Overview

Existing 3D modeling tools automate aspects of movement synthesis to improve efficiency and quality of body motion models created for animating digital content. Conventional text to motion synthesis techniques apply machine learning to generate motion data usable for modeling or rendering based on natural language prompts. Some approaches map motion and language (e.g., text descriptions) into a shared latent space and then sample motions based on the text inputs. To overcome difficulties in learning continuous motion features, motions are quantized into discrete tokens, which enables motion synthesis based on predicted tokens using transformers or fine-tuned large language models. The degree of realism achievable with conventional movement synthesis tools remains limited.

Conventional movement synthesis tools standardize motions by mapping movements to generalized human body models. Homogenized motions are generated across diverse body types, which fail to capture the specific attributes of individual body shapes. In reality, different body shapes perform similar actions with distinct, physiological differences. For example, a taller person takes longer strides when running compared to a person of average build, while a shorter person performs fewer lower body adjustments when transitioning from standing to sitting on the floor.

Standardizing motions across various body types fails to accurately capture the nuanced motion effects caused by shape variations and decreases realism of animations. Treating distinct motions identically during motion synthesis leads to artifacts in subsequent motion transfer efforts, often resulting in unrealistic motions and limits to acceptable body shape variations. Incorporating body shapes in motion synthesis is challenging due to difficulties in obtaining closed form parameterization of motions by body shapes and learning in a data driven manner coarse to fine differences in motions due to individual body shapes. These challenges are intensified when attempting to merge continuous shape representations with quantized motion representations.

A system (e.g., a content processing system) is described that implements shape aware descriptive movement synthesis to synthesize shape aware body motion data for modeling or producing realistic animations described by natural language inputs. The system is an example of a machine learning system (e.g., pipeline, model, framework, architecture) trained to integrate body shape descriptions during body motion synthesis. Unlike conventional motion synthesis techniques that standardize motions based on a normalized body model, the machine learning system outputs motion data that is tailored to diverse body shapes described by inputs, e.g., text inputs, transcribed audio inputs. The machine learning system is trained to accurately model motion effects observed when similar body motions are performed by different body shapes.

In an example implementation, the system receives a description of a body motion and a body shape. For example, the description is typed or spoken to a user interface that processes user inputs into inputs to the system. The system executes a large language model that is trained to jointly predict a shape parameter and a plurality of motion tokens from the description. The shape parameter defines the body shape, and the motion tokens represent the body motion of the body shape. By jointly predicting the shape parameter and the motion tokens, the large language model captures the nuanced physiological differences in how individuals with varying body types perform actions.

To transform the output from the large language model into motion data usable for modeling or animating, the joint predictions from the large language model are processed through a trained finite scalar quantizer and a combiner. The combiner generates a plurality of shape conditioned motion features by integrating a shape feature projected from the shape parameter with a plurality of discrete motion features output from the finite scalar quantizer based on (e.g., a de-quantization of) the motion tokens. By integrating the shape feature with the discrete motion features, the system overcomes challenges with parameterizing motions based on body shapes and learning fine grained motion differences based on the body shapes. The shape integration improves realism for applications that eventually process motion data output from the system, such as to support content creation, simulation, gaming, and interactive media.

A motion decoder is trained to decode the shape conditioned motion features into motion data, e.g., a body shape motion model, a body shape model. The system outputs the motion data, which is usable to generate a realistic animation of the described body shape performing the described body motion. An animation rendered from the motion data realistically depicts motion variations observed with movements made by the described body shape. An output from the system enables more realistic and diverse animations, addressing the limitations of conventional one size approaches that fail to account for shape specific motion characteristics.

The machine learning system is trained in multiple stages. The finite scalar quantizer and the motion decoder are trained on shape normalized motions and corresponding shape parameters, and the large language model is trained separately to predict the shape parameter and the motion tokens from shape and motion descriptions. Using a multistage training approach configures each part of the machine learning system to specialize on a corresponding task, resulting in more accurate and nuanced motion synthesis that accounts for body shape variations. When trained, the machine learning system is configured to integrate various physical constraints, which during inference, are used to improve realism of the motion synthesis. The physical constraints, such as floating loss, foot sliding loss, and bone length loss, help the machine learning system to maintain the physical plausibility of the synthesized motions across different body shapes. The trained machine learning system generates realistic motion data for applications in various fields including animation, gaming, and virtual reality. The motion data synthesized by the system has improved realism over conventional approaches, by successfully capturing specific attributes of individual body shapes and distinct physiological differences in motion across diverse body types.

Further discussion of these and other examples and advantages are included in the following sections and shown using corresponding figures. In the following discussion, an example environment is described that employs the techniques described herein. Example processes are also described that are performable in the example environment as well as other environments. Consequently, performance of the example processes is not limited to the example environment and the example environment is not limited to performance of the example processes.

### Example Environment for Assessing Clip Assembly Coherency

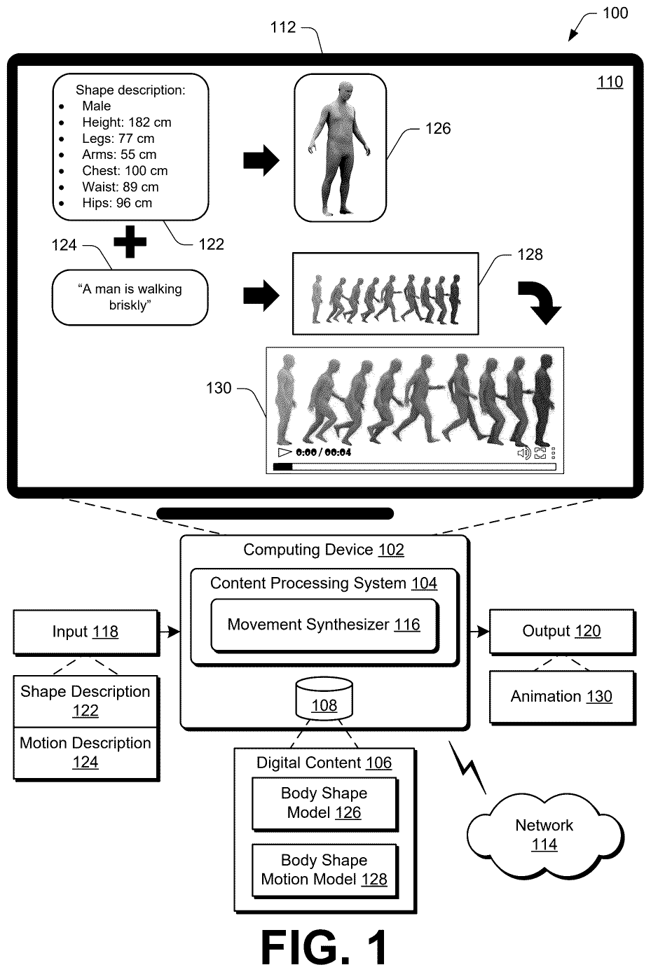

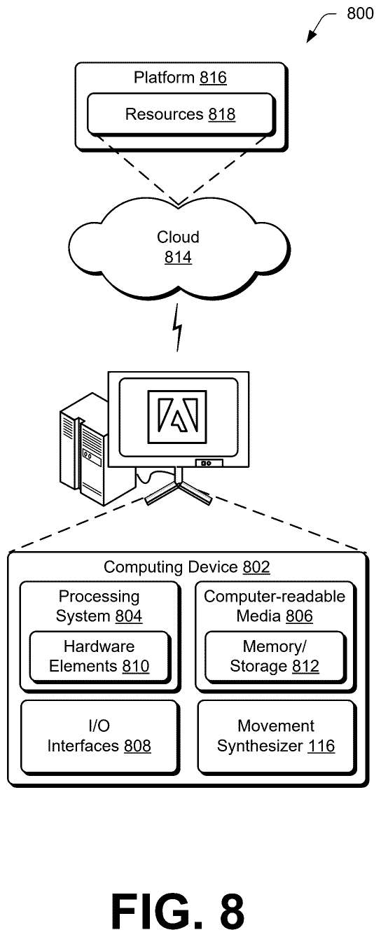

FIG. 1 illustrates an environment 100 for synthesizing shape aware descriptive movements. The environment 100 includes a computing device 102, which is configurable in a variety of ways. The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 8.

The computing device 102 is illustrated as including a content processing system 104. The content processing system 104 is implemented at least partially in hardware of the computing device 102 to process and transform digital content 106, which is illustrated as being maintained in a data storage 108 of the computing device 102. Such processing includes creation of the digital content 106, such as body shape models and body shape motion models. Other examples of such processing include modification of the digital content 106, and production of the digital content 106 for presentation in a user interface 110, e.g., for output by a display device 112.

The computing device 102 is depicted as being connected to a network 114, which enables communication with other devices or systems. The network 114 enables the computing device 102 to access additional resources or data to support functionality of the content processing system 104. Although illustrated as implemented locally at the computing device 102, functionality of the content processing system 104 is also configurable in whole or in part through functionality available via the network 114, such as part of a web service or in the cloud.

An example of functionality incorporated by the content processing system 104 for processing the digital content 106 is illustrated as a movement synthesizer 116, which is configured to handle complex data processing tasks by receiving input 118 and generating output 120. The movement synthesizer 116 is operable to analyze the input 118 to synthesize shape aware descriptive movements. The movement synthesizer 116 is trained to recognize patterns and relationships between body shapes and motions to determine realistic motion synthesis. The movement synthesizer 116 enables the content processing system 104 to generate shape aware body motion data for modeling or producing realistic animations described by natural language inputs.

The input 118 to the movement synthesizer 116 is depicted as a shape description 122 and a motion description 124. The shape description 122 indicates shape parameters describing physical characteristics of a body shape, such as height, weight, limb proportions, and body type. The shape parameters are based on body models, for instance, such as SMPL (Skinned Multi Person Linear), SMPL X, or SMPL H. The movement synthesizer 116 is capable of converting between different body models in variations. For datasets lacking detailed shape information, techniques like SMPLify are used to fit shape parameters of an SMPL body model from joint locations. The shape descriptions are configured to follow a specific template for constructing inputs, ensuring consistency and completeness of the shape information. The motion description 124 includes text describing a desired motion. The output 120 generated by the movement synthesizer 116 includes a body shape model 126 and a body shape motion model 128. The body shape model 126 represents the described body shape, while the body shape motion model 128 represents the described motion tailored to the body shape. The body shape motion model 128 integrates attributes of the shape to realistically depict motion variations observed with movements made by the described body shape.

The user interface 110 enables users to interact with the content processing system 104, view the body shape model 126 and body shape motion model 128, and provide feedback. The user interface 110 presents the shape description 122 and motion description 124 alongside visual representations of the body shape model 126 and body shape motion model 128. Users are able to manipulate these elements using various controls, and the input 118 instructs the content processing system 104 to generate an animation 130. In examples, the content processing system 104 supports a modeling and rendering tool configured to process motion data and body models into animations and images. For example, the body shape model 126 is input to the modeling and rendering tool, and an image of a person having characteristics defined by the body shape model 126. As another example, the body shape motion model 128 is input to the modeling and rendering tool, and the animation 130 of a person having characteristics defined by the body shape model 126 is produced. The content processing system 104 is configurable to generate an animation from the motion data output from the movement synthesizer 116, and configurable to generate images based on the motion data.

The environment 100 offers a comprehensive solution for synthesizing shape aware descriptive movements by leveraging the movement synthesizer 116 to process input 118 and produce high quality animations with corresponding body shape and body shape motion models. The content processing system 104 accepts the shape description 122 and the motion description 124, from which the movement synthesizer 116 processes the input 118 to create the body shape model 126 and body shape motion model 128. The content processing system 104 generates the animation 130 to provide a visual representation of the shape aware motion synthesis. To evaluate the quality and diversity of the generated motions, various metrics are employable, such as Fréchet Inception Distance (FID), R Precision, and Multimodal Distance (MM Dist). Additionally, a MultiModality metric is usable to measure the diversity in generated motions. Performance of the movement synthesizer 116 is assessable through perceptual studies with user participants, providing qualitative feedback on the realism and accuracy of the synthesized motions. The content processing system 104 overcomes challenges in creating realistic animations by offering automated assistance in shape aware motion synthesis. By utilizing the movement synthesizer 116, the content processing system 104 continuously assesses and enhances motion synthesis, addressing the complexities of generating motions tailored to specific body shapes.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Shape Aware Descriptive Movement Synthesis Architecture

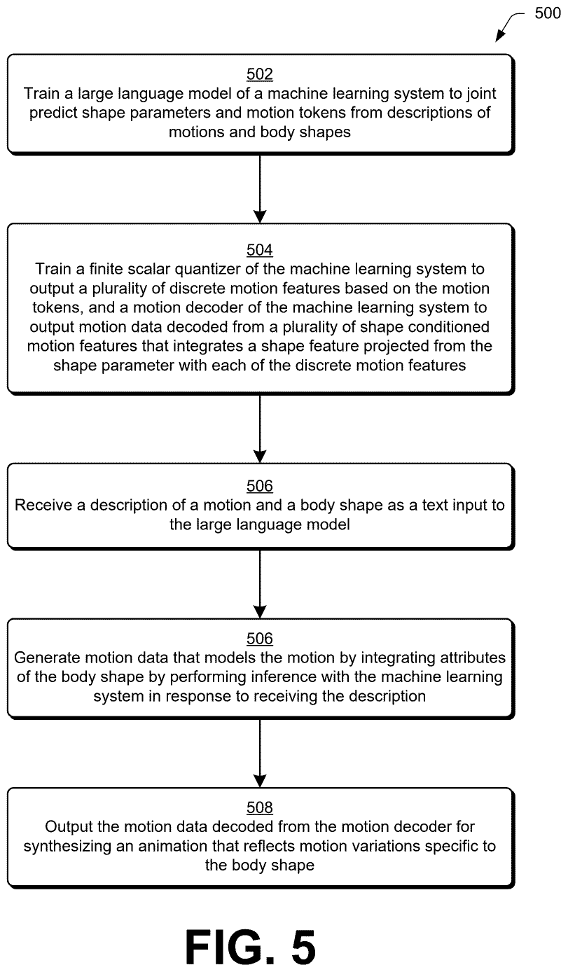

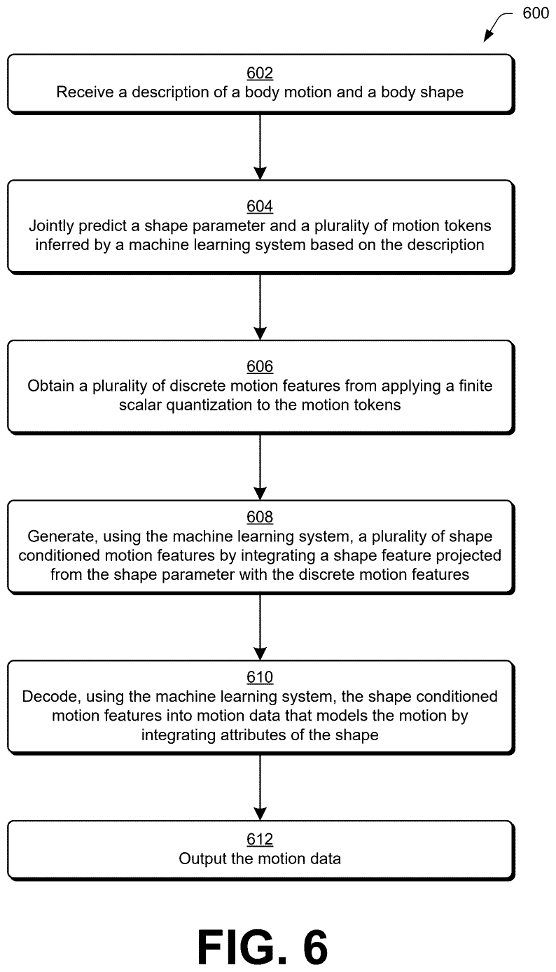

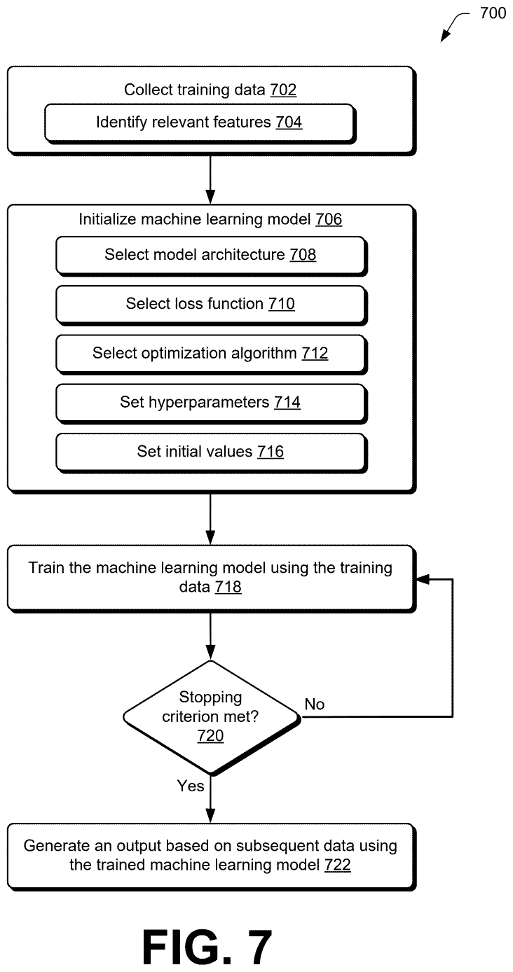

The following discussion describes techniques for shape aware descriptive movement synthesis, which are implementable utilizing the systems and devices described herein. Aspects of each of processes implemented by the systems and devices are implemented in hardware, firmware, software, or a combination thereof. The processes, e.g., as shown in FIG. 5, FIG. 6, and FIG. 7, depict a set of blocks that specify operations performed by one or more devices and are not limited to the orders shown for performing the operations by the respective blocks.

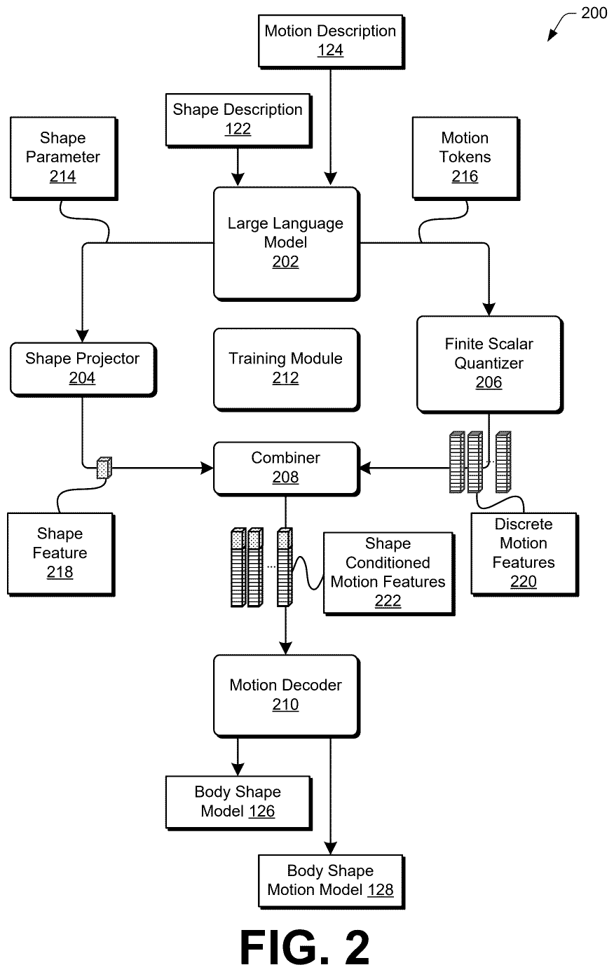

FIG. 2 illustrates a block diagram of a machine learning system 200 trained to employ techniques described herein for shape aware descriptive movement synthesis. The machine learning system 200 comprises several interconnected components designed to process textual descriptions of body shapes and motions and generate shape aware motion data. The machine learning system 200 leverages advanced natural language processing and motion synthesis techniques to analyze and interpret the input descriptions, producing realistic motion data that accounts for the specific attributes of the described body shape.

Serving as the initial point of data entry for the machine learning system 200, the large language model 202 is responsible for processing the input descriptions of body motion and body shape. In aspects, the large language model 202 is implemented using transformer based architecture, which process complex language inputs and predict sequential data while handling continuous information through a managed latent space, enabling the large language model 202 to jointly predict shape parameters and motion tokens from the input descriptions of body shapes and motions. The large language model is based on a pretrained model in variations, such as the T5 language model, which is then fine-tuned for the specific task of shape and motion description processing.

The large language model 202 is trained to jointly predict a shape parameter 214 and a plurality of motion tokens 216 based on the input description. The shape parameter 214 defines characteristics of the body shape, such as height, weight, limb proportions, and body type. For example, the shape parameter 214 specifies values for height (e.g., 180 cm), arm length (e.g., 75 cm), leg length (e.g., 95 cm), chest circumference (e.g., 100 cm), waist circumference (e.g., 80 cm), and hip circumference, e.g., 95 cm). In some implementations, shape attributes is represented using a discrete 5 level Likert scale, allowing for more nuanced descriptions of body characteristics. The shape parameter 214 allows the machine learning system 200 to generate motions tailored to specific body types. The motion tokens 216 represent discrete elements of the body motion described in the input. For instance, motion tokens encode information about limb positions, joint angles, velocity, and acceleration at different time steps of the motion sequence. As an example, for a walking motion, tokens represent stride length, arm swing, hip rotation, and other aspects of the gait cycle. By jointly predicting the shape parameter 214 and the motion tokens 216, the large language model 202 captures the nuanced physiological differences in how individuals with varying body types perform actions. The joint prediction configures the machine learning system 200 to generate realistic motions that account for how body shape impacts movement patterns.

The shape projector 204 processes the shape parameter 214 output by the large language model 202. The shape parameter 214 is projected into a shape feature 218, which is a representation of the body shape that integrates with motion data, e.g., the discrete motion features 220. For example, the shape projector 204 transforms abstract shape parameters, such as height, weight, limb proportions, and body type, into a format that is efficiently combinable with motion information, such as a vector of numerical values representing body measurements or a set of coefficients for a parametric body model.

The finite scalar quantizer 206 processes the motion tokens 216 generated by the large language model 202 by applying finite scalar de-quantization to the motion tokens 216, producing discrete motion features 220. The de-quantization process helps in efficiently representing complex motion data in a discrete, manageable form while preserving other motion characteristics. For instance, the finite scalar quantizer 206 converts continuous motion values into a finite set of discrete values, such as transforming joint angles or positional coordinates into a predefined number of quantization levels. In aspects, the quantization involves mapping the motion feature to a motion token 216, which constitutes a similar representative value within a codebook, effectively compressing the motion information while maintaining specific attributes. Quantization maps features to tokens in a codebook. De-quantization then maps those codebook tokens back to features to eventually get back raw motion data. The finite scalar quantizer 206 is configured or trained in examples to perform vector quantization/de-quantization, where groups of the motion tokens 216 are quantization/de-quantized together to capture temporal dependencies in the discrete motion features 220. The input to the vector quantization/de-quantization process includes shape normalized motions, for instance, which allow the machine learning system 200 to focus on motion characteristics independent of specific body shapes, facilitating more effective quantization/de-quantization and subsequent shape aware synthesis.

The combiner 208 integrates the outputs from the shape projector 204 with the outputs from the finite scalar quantizer 206. Specifically, the combiner 208 integrates (e.g., combines, concatenates, intersperses, fuses) the shape feature 218 with the discrete motion features 220 to generate shape conditioned motion features 222. The integration incorporates body shape information into the motion synthesis process, allowing for the generation of motions that are tailored to specific body shapes. For example, the combiner 208 concatenates or combines in another way the shape feature 218 (e.g., a vector) representing body measurements (e.g., height, arm length, leg length, chest circumference) with the discrete motion features 220 by encoding joint positions or angles at different time steps. A concatenation, for instance, appends the shape feature 218 to each frame of the discrete motion features 220, creating a unified representation that captures both shape and motion information. In at least one example, the combiner 208 uses more sophisticated fusion or integration techniques, such as element wise multiplication or attention mechanisms, to combine the shape information encoded by the shape feature 218 in modulation to the discrete motion features 220 dynamically. The integration of shape and motion information enables the machine learning system 200 to decode motion data, which accounts for how different body shapes affect movement patterns, such as adjusting stride length based on leg proportions or modifying upper body rotations based on torso dimensions.

The motion decoder 210 is a final component in a processing pipeline of the machine learning system 200 and receives the shape conditioned motion features 222 as input and decodes the input into motion data. Examples of the motion data produced by the decoder includes a body shape model 126 and a body shape motion model 128, which represent the described body shape, and the motion tailored to that specific shape, respectively. The motion decoder 210 is implemented as a neural network in at least one example, such as a recurrent neural network (RNN) or a transformer based architecture, specifically trained to reconstruct continuous motion sequences from the shape conditioned motion features 222. The motion decoder 210 generates, for instance, a sequence of joint rotations, positions, or other motion parameters that define the movement over time. For example, the motion decoder 210 outputs a series of 3D joint positions for each frame of the shape conditioned motion features 222 or produce joint angle rotations for being applied to a skeletal rig. The motion decoder 210 is operable to ensure smooth transitions between poses and maintain physical consistency, such as enforcing bone length constraints or applying inverse kinematics to adjust end effector positions. Additionally, the motion decoder 210 is operable to generate secondary motion effects, such as subtle body sways or weight shifts, which contribute to the realism of the synthesized motion while accounting for the specific body shape characteristics.

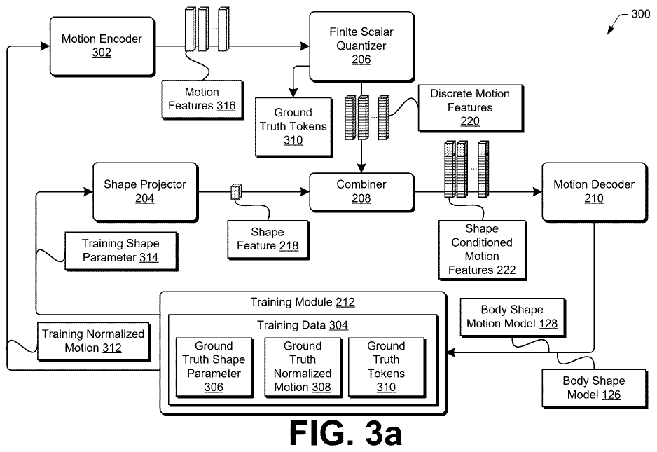

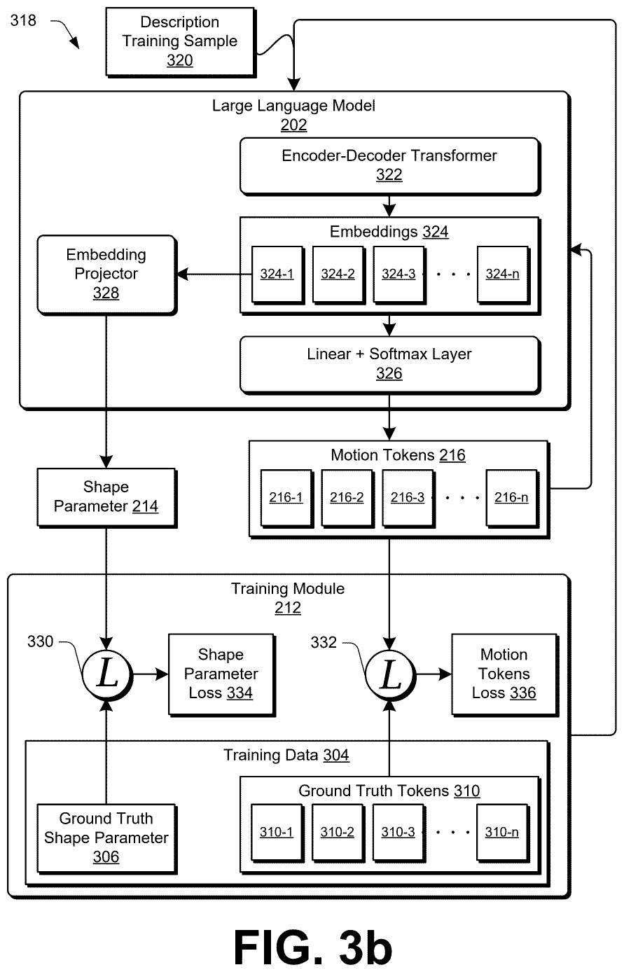

The training module 212 is responsible for the training and overall optimization of the machine learning system 200, and manages the training process for each component, ensuring that the machine learning system 200 learns to accurately predict shape parameters and motion tokens, perform effective quantization and de-quantization, and generate realistic shape aware motions. The training module 212 orchestrates a multistage training approach, which allows each part of the machine learning system 200 to specialize in specific tasks. In the first stage, as illustrated in FIG. 3a, the training module 212 focuses on training the finite scalar quantizer 206 and the motion decoder 210 using shape normalized motions and corresponding shape parameters. The first stage establishes the foundation for effective motion representation and reconstruction. In the second stage, depicted in FIG. 3b, the training module 212 directs the training of the large language model 202 to predict shape parameters and motion tokens from textual descriptions of shapes and motions. The training module 212 employs various loss functions, such as shape parameter loss and motion token loss, to optimize the performance of each component. Specific loss functions include L1 smooth for reconstruction loss, ensuring smooth and accurate motion reconstruction. In variations, the training module 212 incorporates physical constraints like floating loss, foot sliding loss, and bone length loss during training to ensure the physical plausibility of the synthesized motions across different body shapes. The training process includes data augmentation strategies, such as replacing a percentage of ground truth shape parameters with synthetically generated parameters, to improve model robustness and generalization capabilities. By managing the multistage training process with various optimization techniques, the training module 212 enables the machine learning system 200 to generate more accurate and nuanced motion synthesis that accounts for body shape variations.

In operation, after being trained by the training module 212, the machine learning system 200 implements shape aware descriptive movement synthesis. The large language model 202 receives the motion description 124 and the shape description 122 as inputs. Based on the inputs, the large language model 202 jointly predicts the shape parameter 214 and the motion tokens 216. The finite scalar quantizer 206 outputs the discrete motion features 220 from applying a finite scalar de-quantization to the motion tokens 216. The combiner 208 in combination with the shape projector 204 generates the shape conditioned motion features 222 by integrating (e.g., concatenating) the shape feature 218 projected from the shape parameter 214 with the discrete motion features 220. The motion decoder 210 decodes the shape conditioned motion features 222 into motion data, depicted as the body shape model 126, and the body shape motion model 128 that models the motion by integrating attributes of the shape.

FIG. 3a illustrates a block diagram of first training stage 300 of a training architecture of the machine learning system shown in FIG. 2. The training module 212 orchestrates the first training stage 300 by coordinating various operations using the elements depicted in the block diagram and described below.

The first training stage 300 uses a motion encoder 302 (e.g., a neural network) that processes a training normalized motion 312 received from the training module 212 to generate a plurality of motion features 316. The training module 212 orchestrates the first training stage 300 by accessing training data 304 and obtaining a ground truth normalized motion 308 that is used as the training normalized motion 312 output to train the motion encoder 302. The motion encoder 302 is trained to generate the motion features 316 based on the training normalized motion 312.

The motion features 316 transform the training normalized motion 312 (e.g., a parameterized representation) into a latent representation. From the latent representation, the motion features 316 are usable as training inputs to the finite scalar quantizer 206 for learning to quantize the motion features 316 into ground truth tokens 310, and further to de-quantize the ground truth tokens 310 into the discrete motion features 220 associated with the training normalized motion 312. Outside of training (e.g., during inference) the motion feature input to the finite scalar quantizer 206 is disabled to configure the finite scalar quantizer 206 to map (e.g., de-quantize) the motion tokens 216 directly into the discrete motion features 220.

The training module 212 activates the finite scalar quantizer 206 to generate the discrete motion features 220 by de-quantizing the ground truth tokens 310. The motion features 316 are input to the finite scalar quantizer 206 and through finite scalar quantization are mapped to the ground truth tokens 310. Once trained, the finite scalar quantizer 206 applies a finite scalar de-quantization to motion token inputs to generate discrete motion features, and in reverse, the finite scalar quantizer 206 applies a finite scalar quantization to motion features to generate the motion tokens. The ground truth tokens 310 are output from the finite scalar quantizer 206 to the training data 304 of the training module 212. As depicted in FIG. 3b, the ground truth tokens 310 are useful during the second training stage to train the large language model 202.

Concurrently, the training module 212 activates the shape projector 204 to process training shape parameters 314, generating shape features 218. Activating the shape projector 204 causes a projection of the training shape parameter 314 (e.g., from a parameterized representation to latent space) that produces the shape feature 218. The training module 212 accesses the training data 304 and obtains a ground truth shape parameter 306 that is used as the training shape parameter 314 output to the shape projector 204. In variations, the ground truth shape parameters 306 are represented using a discrete 5 level Likert scale ranging from 1 (strongly disagree) to 5 (strongly agree) for predicting SMPL X shape parameters. In at least one example, the shape projector 204 utilizes the Attributes to Shape (A2S) model from SHAPY to generate additional shape features for training. The shape projector 204 converts gender specific shape parameters to a neutral gender format, for example, to enhance generalization balanced with shape aware realism.

The combiner 208 is configured to integrate continuous shape information included in the shape feature 218 with each of the discrete motion features 220. The training module 212 directs the combiner 208 to combine the shape features 218 with the discrete motion features 220, producing the shape conditioned motion features 222.

The motion decoder 210 is trained by the training module 212 to processes the shape conditioned motion features 222 to generate outputs that are used to create motion data, including the body shape model 126, the body shape motion model 128, or other representations of the shape enhanced motion synthesized by the movement synthesizer 116. The training module 212 trains the motion decoder 210 to generate motion data. In variations, the motion decoder 210 and the motion encoder 302 are operatively coupled, including in examples part of a single neural network trained to encode and decode using a single model. The body shape model 126 and the body shape motion model 128 are received by the training module 212 and stored among the training data 304, which is later used to train the large language model 202 and optimize loss throughout the machine learning system 200, as described in relation to FIG. 3b.

The training module 212 controls the motion encoder 302 and the shape projector 204 to operate in parallel, feeding into the finite scalar quantizer 206 and the combiner 208, respectively. The finite scalar quantizer 206 employs a bounding function in the finite scalar quantization and de-quantization processes in at least one example and uses straight through gradients in variations. The shape feature 218 and the discrete motion features 222 are then combined and processed by the motion decoder 210 to produce the body shape model 126 and the body shape motion model 128. The training module 212 is configurable to optimize the training process by employing specific hyperparameters, such as learning rates and batch sizes, and training durations optimized for the architecture. The first training stage 300 establishes a foundation for effective motion representation and reconstruction, preparing the machine learning system 200 for the second stage of training depicted in FIG. 3b.

FIG. 3b illustrates a block diagram of a second training stage 318 of the training architecture implemented separate from the first training stage 300 shown in FIG. 3a. The training module 212 orchestrates the second training stage 318 by coordinating various operations using the elements depicted in the block diagram and described below.

The second training stage 318 trains the large language model 202, which processes a description training sample 320 received from the training module 212, to generate a series of embeddings 324 that lead to the creation of the shape parameter 214 and the motion tokens 216 (e.g., motion token 216-1, motion token 216-2, motion token 216-3, and motion token 216-n, where n is any integer). The training module 212 orchestrates the second training stage 318 by accessing training data 304 and obtaining description training samples 320 that are used as training inputs to the large language model 202. In examples, the training module 212 generates the description training sample 320 by converting one or more ground truth shape parameters 306 and the ground truth tokens 310 (e.g., ground truth token 310-1, ground truth token 310-2, ground truth token 310-3, and ground truth token 310-n) into a motion and shape description training example.

The large language model 202 is configurable to incorporate attention mechanisms and transformer architectures. An encoder decoder transformer 322 of the large language model 202 transforms the description training sample 320 (e.g., a text representation) into a latent representation conveyed by the embeddings 324. From the latent representation, the embeddings 324 are processed through an output layer 326 and an embedding projector 328. The output layer 326 generates motion tokens 216, while an embedding projector 328 produces a shape parameter 214 by parameterizing a shape embedding 324-1 out of the latent space. In addition to the shape embedding 324-1, the embeddings 324 include a first motion embedding 324-2, a second motion embedding 324-3, and so forth, up to and including an nth motion embedding 324-n, where n is any integer greater than one. Outside of training (e.g., during inference), the large language model 202 is configured to directly output the motion tokens 216 and shape parameter 214 based on input descriptions.

The output layer 326 generates motion tokens 216, while an embedding projector 328 produces a shape parameter 214 by parameterizing a shape embedding 324-1 out of the latent space. The output layer 326 employs a Linear plus SoftMax approach to generate the motion tokens 216, which involves two steps, including linear transformation and SoftMax activation. In the linear transformation step, the embeddings 324 are first passed through a linear layer, which applies a learned weight matrix W and bias vector b to the input. For an input embedding x, this operation is represented as z=Wx+b, where z is the resulting vector after the linear transformation. The SoftMax activation step follows, where the output of the linear layer is passed through a SoftMax function, which converts the vector into a probability distribution over the possible motion tokens. The SoftMax function is defined as SoftMax(z_i)=e\hat{ }(z_i)/(sum from j=1 to K of e\hat{ }(z_j)), where K is the number of possible motion tokens, and z_i is the i-th element of the vector z. For example, if there are 1000 possible motion tokens 216, the linear layer possibly transforms an embedding of dimension 512 into a vector of dimension 1000. The SoftMax function then converts the vector into a probability distribution over the 1000 possible motion tokens. The motion token with the highest probability is selected as the output. The output layer 326, including the Linear plus SoftMax approach, allows the large language model 202 to learn a mapping from the continuous embedding space to a discrete set of motion tokens, enabling the generation of coherent and diverse motion data. The training module 212 activates the output layer 326 to generate the motion tokens 216.

Concurrently, the training module 212 activates the embedding projector 328 to process the shape embedding 324-1 for generating the shape parameter 214. Activating the embedding projector 328 causes a projection of the shape embedding 324-1 (or multiple shape embeddings in variations where multiple shape parameters are inferred from the input) that produces the shape parameter 214.

The training module 212 implements a shape loss function 330 and a motion loss function 332 to optimize the large language model 202. The shape loss function 330 generates a shape parameter loss 334 by comparing the shape parameter 214 with the ground truth shape parameter 306. The training module 212 accesses the training data 304 and obtains the ground truth shape parameter 306 that is used to evaluate the shape parameter 214 output by the embedding projector 328. In variations, the ground truth shape parameters 306 are represented using a discrete 5 level Likert scale ranging from 1 (strongly disagree) to 5 (strongly agree) for predicting SMPL X shape parameters. The motion loss function 332 of the training module 212 generates a motion tokens loss 336 by comparing the motion tokens 216 with the ground truth tokens 310.

The training module 212 controls the large language model 202, including the output layer 326, and the embedding projector 328, to operate in parallel, feeding into the loss function 330 and the loss function 332. The shape parameter 214 and the motion tokens 216 are then evaluated using the loss functions to optimize performance of the large language model 202. The training module 212 is configurable to optimize the training process by employing specific hyperparameters, such as learning rates and batch sizes, and training durations optimized for the architecture. The second training stage 318 builds upon the foundation established in the first training stage 300, enabling the machine learning system 200 to effectively combine shape and motion information for more accurate and nuanced motion synthesis.

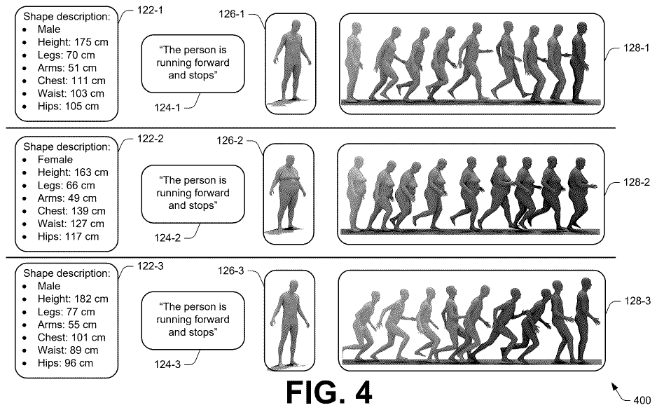

FIG. 4 illustrates examples 400 of inputs and corresponding outputs from a content processing system that is operable to employ techniques described herein for shape aware descriptive movement synthesis. The examples 400 depict shape aware motion synthesis performed using three different body types to perform a same running motion. FIG. 4 displays three rows of different examples of the input 118, each including a different shape description and same motion description, and different examples of the output 120, each including a different body shape model and different corresponding body shape motion model. In each of a first shape description 122-1, a second shape description 122-2, and a third shape description 122-3, respective text is included describing characteristics of a different human body.

The first row shows a first shape description 122-1 specifying parameters for a male figure with height 175 cm, legs 70 cm, arms 51 cm, chest 111 cm, waist 103 cm, and hips 105 cm. The first row also shows a first motion description 124-1 stating “The person is running forward and stops.” A first body shape model 126-1 depicts the static pose of the described male body type incorporating the first shape description 122-1, while a first body shape motion model 128-1 shows a sequence of poses of the first body shape model 126-1 illustrating the running motion inferred from the first motion description 124-1.

The second row includes a second shape description 122-2 describing a female figure with height 163 cm, legs 66 cm, arms 49 cm, chest 139 cm, waist 127 cm, and hips 117 cm. The second motion description 124-2 corresponds to the first motion description 124-1. A second body shape model 126-2 depicts the static pose of the described female body type incorporating the second shape description 122-2, while a second body shape motion model 128-2 shows a sequence of poses of the second body shape model 126-2 illustrating the running motion inferred from the second motion description 124-2.

The third row presents a third shape description 122-3 for a male figure with height 182 cm, legs 77 cm, arms 55 cm, chest 101 cm, waist 89 cm, and hips 96 cm. The third motion description 124-3 corresponds to the first motion description 124-1 and the second motion description 124-2. A third body shape model 126-3 depicts the static pose of the described male body type incorporating the third shape description 122-3, while a third body shape motion model 128-3 shows a sequence of poses of the third body shape model 126-3 illustrating the running motion inferred from the third motion description 124-3.

By comparing the three rows of outputs, variations in the body shape model 126 and the body shape motion model 128 output from the movement synthesizer 116 are observable, as the machine learning system 200 accounts for shape induced motion variations and improves realism. The first body shape model 126-1 depicts a medium built male figure, while the second body shape model 126-2 shows a shorter female figure with larger proportions, and the third body shape model 126-3 presents a taller, leaner male figure. The shape variations are reflected in the corresponding body shape motion model 128. For instance, the first body shape motion model 128-1 shows an average stride length and arm swing, while the second body shape motion model 128-2 depicts shorter strides but more pronounced hip movement. The third body shape motion model 128-3 illustrates longer strides and a more elongated running posture. Additionally, the motion sequences produced from motion data output by the movement synthesizer 116 often reveal subtle differences in balance, weight distribution, and overall fluidity of movement, highlighting how the machine learning system 200 automatically adapts the same running motion to the different body shapes.

In aspects, the movement synthesizer 116 is configured to generate a first animation 130 from the first motion data that depicts first motion variations in the body motion performed by the first body shape. Then, in response to receiving a second description of the body motion and a second body shape that is different than the first body shape, the movement synthesizer 116 is configured to generate a second animation from second motion data output from the machine learning model based on the second description that depicts second motion variations in the body motion performed by the second body shape that are different than the first motion variations. For example, a first animation 130 is output for display based on the first body shape motion model 128-1, a second animation 130 is output for display based on the second body shape motion model 128-2, a third animation 130 is output for display based on the third body shape motion model 128-3, and so forth. Through updates to the shape description 122 and/or the motion description 124, seemingly endless variations in body shape and motion variation synthesis is achievable with realistic movement behavior across varying body characteristics.

FIG. 5 illustrates a process 500 for training a machine learning model to implement shape aware descriptive movement synthesis. In some examples, the process 500 describes operations (e.g., of the training module 212) that train the machine learning system 200 for producing the digital content 106 (e.g., the body shape model 126, and the body shape motion model 128) based on the input 118 to output motion data (e.g., the animation 13) to depict the motion conditioned by body shape.

The process 500 begins at step 502, where a large language model of a machine learning system is trained to jointly predict shape parameters and motion tokens from descriptions of motions and body shapes. The step 502, for instance, includes processing training samples including pairs of shape and motion descriptions through the encoder-decoder transformer 322 to generate the embeddings 324. The embeddings 324 are projected to predict shape parameters 214 and motion tokens 216. The large language model 202 is optimizable using combined loss functions 330 and 332 to evaluate a shape parameter loss 334 and a motion token loss 336. For example, the step 502 is described in detail in relation to the second training stage 318 depicted in FIG. 3b.

At step 504, a finite scalar quantizer of the machine learning system is trained to output a plurality of discrete motion features based on the motion tokens, and a motion decoder of the machine learning system is trained to output motion data decoded from a plurality of shape conditioned motion features that integrates a shape feature projected from the shape parameter with each of the discrete motion features. In some aspects, the step 504 uses shape-normalized motions (e.g., the motion features 316) and corresponding shape parameters 314 as training inputs to the finite scalar quantizer 206, which is configured to apply vector de-quantization to groups of motion tokens 310 to capture temporal dependencies in the discrete motion features 222. Additional details of the step 504 are described above in relation to the first training stage 300 depicted in FIG. 3a.

The process 500 then moves to the inference stage at step 506, where a description of a motion and a body shape is received as a text input to the large language model. The input 118, for example, includes detailed body measurements such as height, limb lengths, and body circumferences, as well as a textual description of the desired motion.

At step 508, the process 500 generates motion data that models the motion by integrating attributes of the body shape by performing inference with the machine learning system in response to receiving the description. The step 508 executes the large language model 202, jointly predicting shape parameters 214 and motion tokens 216, the finite scalar quantizer 206 generating discrete motion features 222, and the motion decoder 210 producing the final motion data (e.g., the body shape model 126, the body shape motion model 128, the animation 130). In some cases, physical constraints such as floating loss, foot sliding loss, and bone length loss are applied during inference to maintain the physical plausibility of the synthesized motions across different body shapes.

The process 500 concludes the step 508, where the motion data decoded from the motion decoder is output for synthesizing a rendered motion that reflects motion variations specific to the body shape. The output 120, for example, is in the form of at least one of the body shape model 126 or the body shape motion model 128, which are usable to generate the animations 130 with realism that accurately depicts how the described body shape performs the specified motion.

FIG. 6 illustrates a flowchart of a process 600 for implementing shape aware descriptive movement synthesis. In some examples, the process 600 describes operations of the machine learning system 200 of the movement synthesizer 116 for producing the digital content 106 (e.g., the body shape model 126, and the body shape motion model 128) based on the input 118 to output motion data conditioned by body shape.

The process 600 begins at step 602, where a description of a body motion and a body shape is received. This description is provided as text input to the large language model 202.

At step 604, the process 600 jointly predicts a shape parameter and a plurality of motion tokens based on the description using the machine learning system 200. The large language model 202 outputs the shape parameter 214 and motion tokens 216 in the step 604.

At step 606, the process 600 obtains a plurality of discrete motion features by applying a finite scalar de-quantization to the motion tokens. The step 606 involves using the finite scalar quantizer 206 to apply a finite scalar de-quantization to the motion tokens 216 and generate the discrete motion features 220.

In step 608, the machine learning system 200 generates a plurality of shape conditioned motion features by integrating a shape feature projected from the shape parameter with the discrete motion features. The shape projector 204 projects the shape parameter 214 into the shape feature 218, which is then combined (e.g., concatenated with, interspersed with, added to, appended to) with the discrete motion features 220 by the combiner 208 to produce the shape conditioned motion features 222.

The process 600 continues to step 610, where the shape conditioned motion features are decoded into motion data that models the motion by integrating attributes of the shape. The step 610 uses the motion decoder 210, which processes the shape conditioned motion features 222 to generate outputs that are used to create the body shape model 126 and body shape motion model 128.

Finally, at step 612, the process 600 outputs the motion data. The output 120, for example, is used to synthesize an animation 130 that reflects motion variations specific to the described body shape. In variations, the output 120 includes information for presenting the user interface 110 via the display device 112.

FIG. 7 shows a flow diagram depicting an algorithm as a step by step process 700, which is performable by a processing device when executing a training module for training the machine learning system 200 to implement shape aware descriptive movement synthesis. In some examples, the process 700 describes operations of the training module 212 for configuring the machine learning system 200 to produce motion data, including at least one of the body shape model 126 or the body shape motion model 128. The motion data is usable to generate the animation 130 with confidence that motion variations induced by the body shape are accurately depicted. The process 700 provides one or more examples of generating training data, use of the training data to train aspects of the machine learning system 200, and use of the trained machine learning system 200 to perform a task.

To begin in this example, a machine learning system collects training data (block 702) that is to be used as a basis to train a machine learning model, i.e., which defines what is being modeled. The training data is collectable by the machine learning system 200, for example, from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 704) to a type of task, for which the machine learning model is to be trained. Task examples include classification, natural language processing, generative artificial intelligence, recommendation engines, reinforcement learning, clustering, and so forth. To do so, the machine learning system 200, for instance, collects the training data based on the identified features and/or filters the training data based on the identified features after collection. The training data is then utilized to train a machine learning model.

In order to train the machine learning model in the illustrated example, the machine learning model is first initialized (block 706). Initialization of the machine learning model includes selecting a model architecture (block 708) to be trained. Examples of model architectures include neural networks, convolutional neural networks (CNNs), long short term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 710). The loss function is utilized to measure a difference between an output of the machine learning model (i.e., predictions) and target values (e.g., as expressed by the training data) to be used to train the machine learning model. Additionally, an optimization algorithm is selected (712) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 716) examples of which includes initializing weights and biases of nodes to improve efficiency in training and computational resources consumption as part of training. Hyperparameters are also set (block 714) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 718) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 720), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 720), the procedure 700 continues training of the machine learning model using the training data (block 718) in this example.

If the stopping criterion is met (“yes” from decision block 720), the trained machine learning model is then utilized to generate an output based on subsequent data (block 722). The trained machine learning model, for instance, is trained to perform a task as described above and therefore once trained is configured to perform that task based on subsequent data received as an input and processed by the machine learning model.

### Example System and Device for Clip Assembly Coherency Assessments

FIG. 8 illustrates an example system including various components of an example device usable as any type of computing device as described and/or utilized with reference to FIGS. 1 7 to implement examples of the techniques described herein. FIG. 8 illustrates an example system 800 generally, which includes an example computing device 802 that is representative of one or more computing systems and/or devices that implement the various techniques described herein. This is illustrated through inclusion of the movement synthesizer 116. The computing device 802 is configurable, for instance, as a server of a service provider, as a device associated with a client (e.g., a client device), as an on chip system, and/or as any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. In one or more examples, a system bus includes a single bus structure, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including the hardware elements 810, which are configurable as processors, functional blocks, and so forth. This includes implementation in hardware as an application specific integrated circuit or other logic device formed using one or more semiconductors. The hardware elements 810 are not limited by the materials that form the hardware elements 810, or the processing mechanisms employed therein. For example, processors are configurable as semiconductor(s) and/or transistors, e.g., electronic integrated circuits (ICs). In such a context, processor executable instructions are electronically executable instructions.

The computer-readable media 806 is storage media illustrated as including memory/storage 812. The memory/storage 812 represents memory/storage capacity associated with one or more computer-readable media. The memory/storage 812 is configured as a memory component, for example, which is configured to store the digital content 106. The memory/storage 812 includes volatile media (such as random access memory (RAM)) and/or nonvolatile media, such as read only memory (ROM), Flash memory, optical disks, magnetic disks, and so forth. The memory/storage 812 includes fixed media (e.g., RAM, ROM, a fixed hard drive, and so on) as well as removable media, e.g., Flash memory, a removable hard drive, an optical disc, and so forth. The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile response device, and so forth. Thus, the computing device 802 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal bearing medium that is configured to transmit instructions to the hardware of the computing device 802, such as via a network. Signal media typically embodies computer-readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some examples to implement at least some aspects of the techniques described herein, such as to perform one or more instructions. Hardware includes components of an integrated circuit or on chip system, an application specific integrated circuit (ASIC), a field programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 810 include a processing device coupled to the memory component implemented by the memory/storage 812 to perform operations of the machine learning system 200. The operations, when executed, cause the processing device implemented by the hardware elements 810 to generate the digital content 106 to be stored in the memory/storage 812, which is an example of the data storage 108.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (e.g., at least one computing device 802 and/or processing systems 804) to implement techniques, modules, and examples described herein.

The techniques described herein are supported by various configurations of the computing device 802 and are not limited to the specific examples of the techniques described herein. This functionality is also implementable or partially implementable through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data utilized while computer processing is executed on servers that are remote from the computing device 802. In at least one example, the resources 818 include services provided over the Internet and/or through a subscriber network, such as a cellular or Wi Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device example, implementation of functionality described herein is distributable throughout the system 800. The functionality is implementable in part on the computing device 802 as well as via the platform 816 that abstracts the functionality of the cloud 814

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method, comprising:
receiving, by a processing device, a description of a body motion and a body shape;
jointly predicting, by the processing device, a shape parameter and a plurality of motion tokens inferred by a machine learning system based on the description;
obtaining, by the processing device, a plurality of discrete motion features from applying a finite scalar de-quantization to the motion tokens;
generating, by the processing device, using the machine learning system, a plurality of shape conditioned motion features by integrating a shape feature projected from the shape parameter with the discrete motion features;
decoding, by the processing device, using the machine learning system, the shape conditioned motion features into motion data that models the motion by integrating attributes of the shape; and
storing, by the processing device, the motion data.

2. The method of claim 1, the jointly predicting including using a large language model of the machine learning system trained to output the shape parameter and the plurality of motion tokens jointly predicted by the large language model based the description.

3. The method of claim 1, the obtaining including using a finite scalar quantizer of the machine learning system trained to apply the finite scalar de-quantization to the motion tokens.

4. The method of claim 1, the generating including using a combiner of the machine learning system that integrates the shape feature with each of the discrete motion features.

5. The method of claim 1, the decoding including using a motion decoder of the machine learning system trained to output the motion data in response to receiving the shape conditioned motion features.

6. The method of claim 1, wherein the motion data represents a body shape motion model configured as an input to a modeling and rendering tool that generates an animation from the body shape model.

7. The method of claim 1, wherein the motion data represents a body shape model configured as an input to a modeling and rendering tool that generates an image based on the body shape model.

8. A system comprising:
a memory component; and
a processing device coupled to the memory component to perform operations, the operations including:
receiving a description of a body motion and a body shape;
inputting the description into a machine learning system trained to generate motion data that models the body motion that integrates attributes of the shape a shape parameter and a plurality of motion tokens jointly predicted from the description, and decodes the motion data from a plurality of shape conditioned motion features generated a shape feature projected from the shape parameter integrated with a plurality of discrete motion features obtained from a finite scalar de-quantization applied to the motion tokens; and
outputting the motion data for synthesizing the body motion with motion variations specific to the body shape.

9. The system of claim 8, the operations further including:
generating an image from the motion data that depicts the body shape of the description; and
outputting the image for display by a display device coupled to the system.

10. The system of claim 9, wherein the motion data represents a body shape model.

11. The system of claim 8, the operations further including:
generating an animation from the motion data that depicts the motion variations in the body motion; and
outputting the animation for display by a display device coupled to the system.

12. The system of claim 11, wherein the motion data represents a body shape motion model.

13. The system of claim 8, wherein the description comprises a first description of the body motion and a first body shape, and the motion data comprises first motion data for synthesizing the body motion with first motion variations specific to the first body shape, the operations further including:
generating a first animation from the first motion data that depicts the first motion variations in the body motion performed by the first body shape;
receiving a second description of the body motion and a second body shape that is different than the first body shape; and
generating a second animation from second motion data output from the machine learning model based on the second description that depicts second motion variations in the body motion performed by the second body shape that are different than the first motion variations.

14. The system of claim 13, wherein the first description and the second description each include respective text describing characteristics of a different human body.

15. The system of claim 8, the operations further including at least one of:
training a large language model of the machine learning system to output the shape parameter and the motion tokens by jointly predicting the shape parameter and the motion tokens based the description;
training a finite scalar quantizer of the machine learning system to apply the finite scalar de-quantization to the motion tokens and output the discrete motion features; or
training a motion decoder of the machine learning system to output the motion data in response to decoding the shape conditioned motion features.

16. The system of claim 8, the operations further including using a combiner of the machine learning system that integrates the shape feature with each of the discrete motion features.

17. A method, comprising:
training, by a processing device, a large language model of a machine learning system to joint predict shape parameters and motion tokens from descriptions of motions and body shapes;
training, by the processing device, a finite scalar quantizer of the machine learning system to output a plurality of discrete motion features based on a finite scalar de-quantization applied to the motion tokens, and a motion decoder of the machine learning system to output motion data decoded from a plurality of shape conditioned motion features that integrate a shape feature projected from the shape parameter with each of the discrete motion features;
generating, by the processing device, motion data that models a motion by integrating attributes of a body shape by performing inference with the machine learning system in response to receiving a description of the motion and the body shape as a text input to the large language model; and
outputting, by the processing device, the motion data decoded from the motion decoder for synthesizing an animation that reflects motion variations specific to the body shape.

18. The method of claim 17, further comprising training the finite scalar quantizer and the motion decoder independent of a second training stage that trains the large language model.

19. The method of claim 17, the training the large language model including:
processing training samples including shape and motion descriptions through an encoder decoder transformer to generate embeddings;
projecting the embeddings to predict shape parameters and motion tokens; and
optimizing the large language model using a loss function that includes a shape parameter loss and a motion token loss.

20. The method of claim 17, further comprising training the machine learning system to integrate physical constraints during inference, the physical constraints including at least one of a floating loss, a foot sliding loss, or a bone length loss.
